(19) United States
(12) Patent Application Publication
(10) Pub. No.: US 2026/0356268 A1
(43) Pub. Date: Nov. 12, 2026

(54) DEVICE FOR MANIPULATING A SURFACE REGION OF A SEAT AND METHOD FOR MANUFACTURE THEREOF

(71) Applicant: Faurecia Autositze GmbH, Hannover (DE)

(72) Inventor: Marcin Pajdak, Mieroszow (PL)

(73) Assignee: Faurecia Autositze GmbH, Hannover (DE)

(21) Appl. No.: 19/567,813

(22) Filed: Mar. 16, 2026

(30) Foreign Application Priority Data
May 9, 2025 (DE) 102025117968.9

(51) Int. Cl. B60N 2/90

(52) U.S. Cl. CPC B60N 2/976

(57) ABSTRACT

A device, preferably a massage or adjustment device, for manipulating a surface region of a seat comprising two film blanks. Of the film blanks, at least one film blank has at least one stretching structure formed therein. In the region of the stretching structure, the two film blanks are connected to each other by a weld seam in such a way that they enclose a fluid-fillable, hollow chamber between them. By changing the fill level of the hollow chamber, the expansion of the stretching structure, which at least partially defines it, can be changed in relation to a stroke direction from a compressed state to an expanded state and back. The corresponding stretching structure has annular folds running around the stroke direction thereof, preferably coaxially or concentrically. Either at least two or each pair of annular folds are directly connected to each other.

### BACKGROUND OF THE INVENTION

### Technical Field

The invention relates to a device for manipulating a surface region of a seat, to a massage mat for a vehicle seat having at least one such device, and to a method for manufacturing a device for manipulating a surface region of a seat.

### Prior Art

Vehicle seats feature expansion bodies in the form of fluid-fillable bladders. Such a bladder typically comprises at least two interconnected film layers, between which a hollow chamber is enclosed. Controlled emptying and filling of the bladder with a fluid causes a corresponding change in volume, which brings about mechanical operation.

The possible stroke of an expansion body designed in this way depends significantly on its construction. Especially large-stroke expansion bodies therefore exhibit individual folds, the behavior of which allows for an increase in the stroke.

DE 10 2019 219 675 A1 discloses a massage mat for a vehicle seat having a plurality of bellows-like stretching structures. In practice, each stretching structure is composed of multiple annular film blanks and one closed film blank which are made of a flexible plastics material and welded together. These stretching structures, open on one side, are arranged with their open side on a flat carrier film, so that each encloses a hollow chamber between itself and the carrier film.

DE 10 2011 088 895 A1 describes a method for manufacturing a stretching structure from at least one film blank, wherein by welding said blank(s), a cover defining an interior space is formed. The actual shape is created in a die, in which the expansion body or the cover thereof is heated and drawn or pressed against a curved surface of the die. This process can be considered deep drawing or thermoforming of the film blank(s). The parts of the film blank(s) that define the interior space are initially stretched together in the same direction, wherein the part that is concave, i.e., dented in the opposite direction, can be removed from the other part when the stretching structure is first filled with fluid and can thus be folded in the correct direction.

US 2019/0308537 A1 discloses a pneumatic device for modifying the seat contour of a vehicle seat, which device has a flat carrier film consisting of a first and a second film layer. A plurality of stretching structures, each defining a hollow chamber, is attached to the second film layer, each hollow chamber being fluidly connected to an opening in the second film layer. Parallel seams connecting the two film layers create individual channels in the carrier film, each of which connects to the openings within the second film layer. This allows the individual stretching structures to be filled and emptied via their corresponding channels.

U.S. Pat. No. 10,793,041 B2 describes another pneumatic device for modifying the seat contour of a vehicle seat. This device features a plurality of stretching structures, each based on moldings incorporated into a second film blank. The hollow chamber of each of these structures, open on one side, is closed by a flat first film blank. In addition to manufacturing the individual stretching structures by injection molding the second film blank, they can alternatively be produced by deep drawing.

Many applications of such devices require a stretching structure with the largest possible stroke in relation to its stroke direction, which has so far been achieved using a bellows-like design. The overlapping folds allow for a generous expansion of the corresponding stretching structure in the expanded state. In contrast, there are limits to achieving the smallest possible dimensions in the compressed state. Compared to constructing each bellows-like stretching structure by welding individual film blanks layer by layer, shaping a film blank using injection molding or deep drawing requires less manufacturing effort and thus results in lower costs. The reduction in individual manufacturing steps also decreases the risk of defects, which can manifest as poor-quality welds and consequently, immediate or rapidly developing leaks. Furthermore, each weld seam increases the stresses within the material caused by the localized heat input, which can lead to undesirable movement behavior in the corresponding stretching structure.

### BRIEF SUMMARY OF THE INVENTION

Against this background, the object of the invention is to improve a device having at least one large-stroke stretching structure in such a way that it has the smallest possible dimensions while simultaneously offering high durability and requiring minimal material. A method for manufacturing such a device should also be provided.

This object is achieved by a device for manipulating a surface region of a seat, preferably a massage or adjustment device, comprising two film blanks, at least one of which film blank has at least one stretching structure formed therein, in the region of which the two film blanks are connected to each other by a weld seam in such a way that they enclose a fluid-fillable, hollow chamber between them, wherein by changing the fill level of the or each hollow chamber, the expansion of the stretching structure, which at least partially defines it, can be changed in relation to a stroke direction from a compressed state to an expanded state and back, characterized in that the corresponding stretching structure has annular folds running around the stroke direction thereof, preferably coaxially or concentrically, wherein either at least two or each pair of annular folds are directly connected to each other and the outer radius of the annular fold that runs closer around the stroke direction is equal to the inner radius of the annular fold connected thereto, or/and at least two or each pair of annular folds are connected to each other by an annular wall and the outer radius of the annular wall that runs closer around the stroke direction is less than or equal to the inner radius of the other annular wall.

This object is achieved by a massage mat, preferably for a vehicle seat, comprising one of the following alternative compositions: a) a carrier layer having multiple devices arranged thereon, preferably by means of welding, as taught herein; b) a device as taught herein, wherein only one of the film blanks has multiple stretching structures, wherein the stretching structures of one film blank together with regions of the other film blank, preferably serving as a carrier layer, each enclose a common hollow chamber between them; c) a device as taught herein, wherein both film blanks each have multiple stretching structures, wherein the stretching structures of one film blank together with the stretching structures of the other film blank each enclose a common hollow chamber between them.

This object is achieved by a method for manufacturing a device for manipulating a surface region of a seat, preferably a massage or adjustment device, preferably as taught herein, comprising the steps of: providing two film blanks; forming at least one stretching structure in at least one of the film blanks; arranging the film blanks at least partially one above the other; forming a fluid-fillable, hollow chamber in the region of the or each stretching structure between the film blanks by connecting them via a weld seam, characterized in that the stretching structure or each stretching structure is formed by thermoforming, which has a central plateau, wherein annular folds or annular walls and annular folds are formed around the plateau, preferably coaxially or concentrically, which are arranged both between two of these annular walls and between the plateau and the annular wall that runs closest around the plateau.

According to the invention, a device having a stretching structure is provided which has annular folds running around the stroke direction thereof, two of which are connected to one another by an annular wall. In this arrangement, of any two annular folds interconnected by an annular wall, the outer radius of the annular fold that runs closer around the stroke direction is less than or equal to the inner radius of the other annular fold. In other words, the theoretical vertical shadow cast by the individual annular folds, disregarding the annular walls, would thus exhibit either a completely closed circular shadow or a round shadow interrupted by an annular gap at least between two of the annular folds. Preferably, the individual annular folds can be arranged coaxially or concentrically to each other.

The term “annular fold” as used in the present invention refers to a fold defined by two closed curves. The inner curve corresponds to the inner radius of the annular fold, while the outer curve corresponds to the outer radius of the same annular fold. Both of these curves can be circular. Alternatively, the two curves can have a different geometric shape. Of course, a combination is also conceivable in which one of the two curves is circular, while the other curve has a different shape. Within the scope of the invention, a “different shape” is understood to mean any shape that differs from a circular shape. Such a shape can be, at least in portions, elliptical, rectangular, wavy, stepped, or otherwise irregular, to name just a few possible configurations (this list is not exhaustive). In principle, the inner radius of the inner curve and/or the outer radius of the outer curve can be either uniform or uneven across the entire circumference of the annular fold. The plane of the fold defined by the closed curves can be flat or uneven in any conceivable way. This refers to its extent in the circumferential direction of the annular fold and/or the radial extent thereof. With reference to the feature according to the invention, the inner radius and the outer radius are considered to be those distances from the center or a central point of the stretching structure resulting from the corresponding intersection of the inner curve (for the inner radius) and the outer curve (for the outer radius) with a radial line. What has been said about the term “annular fold” also applies, at least in substance, to the term “annular wall” as used within the scope of the present invention.

The advantage arising from the design according to the invention of the device lies substantially in the fact that its stretching structure, preferably each stretching structure, does not have superimposed folds in relation to the stroke direction, but rather individual annular folds interconnected by annular walls, which are arranged successively within a radial corridor extending away from the stroke direction. This allows for extremely small dimensions to be achieved in the compressed state. Furthermore, by forming the individual annular folds and annular walls within at least one film blank, there is no need to construct the stretching structure using individual parts, which is costly and involves considerable material waste. According to the invention, the annular folds and annular walls of the or each stretching structure are one-piece components of a film blank made of an individual material, into which the stretching structure is introduced by a suitable method.

If the device has only an individual hollow chamber between two film blanks, it can also be referred to as an expansion body or a bladder. This applies regardless of whether only one or both film blanks have a stretching structure. In contrast, the device can be referred to as an adjustment device or, alternatively, as an expansion arrangement or expansion system if it has more than an individual hollow chamber. In its function, it can then serve, for example, to adjust the hardness or softness of at least one surface region of a seat, preferably a vehicle seat. Additionally or alternatively, it can also be used to adjust the texture of a surface in order to increase the comfort of a person using the seat or to improve their support in the seat. Further alternatively, the device can also serve a massage function, in which case it can also be referred to as a massage device, massage arrangement, or massage mat, preferably if it has more than an individual hollow chamber. This applies regardless of whether only one or both film blanks have a stretching structure in each hollow chamber. This makes it possible to move or vibrate at least some regions of the surface of a seat in order to stimulate individual muscles of the person using the seat and promote relaxation.

The two film blanks can preferably be two separate portions of a film. Of course, it is also conceivable that an individual, continuous piece of film is used, through the folding of which two of its portions are arranged one above the other, thus being integrally formed from an individual material and interconnected along the fold.

Preferably, each annular wall of the or each stretching structure can be angled along a fold edge relative to at least one annular fold connected thereto. The fold edges are formed in the film blank in a suitable manner to achieve controlled expansion and compression behavior of the or each stretching structure. Preferably, the fold edges can be round or circular, so that the annular folds and annular walls can also have a correspondingly round or circular shape. Compared to the movement in the region of individual parts of such a stretching structure that are interconnected by welds, the fold edges incorporated into the material itself exhibit greater durability.

With regard to the design of the or each stretching structure, the invention provides that the annular folds thereof, when the stretching structure is in the compressed state, can extend alternately in one of two planes spaced apart from each other in relation to the stroke direction. This means that, for example, an annular fold extends in a first plane, while an immediately adjacent annular fold lies in a second plane spaced apart from the first plane. Preferably, the two planes can be spaced apart from and parallel to each other. Together with the annular walls extending between each of the two annular folds, the cross section of the stretching structure in the compressed state thus exhibits a kind of toothing or rectangular curve. In this way, the folding of the stretching structure in other such devices, which is otherwise superimposed in relation to the stroke direction, extends in a direction perpendicular to the stroke direction, allowing for extremely compact dimensions.

Preferably, the corresponding stretching structure of the device can have a central plateau. The axis of the stroke direction can extend through the center of the plateau. The plateau is defined by a circumferential fold edge, the annular fold of the stretching structure that runs closest around the stroke direction being connected to the plateau by an annular wall along this fold edge and being angled relative thereto. Advantageously, the plateau can be round or circular. Preferably in the expanded state of the or each stretching structure, its plateau can then form the highest point.

If the or each stretching structure of the device has a central plateau, a connection, preferably a single connection, can be provided thereon, which is fluidly connected to the or each associated hollow chamber of the device. In this way, it is possible to introduce fluid inro the hollow chamber through the or each connection and to expel it again in order to obtain the desired fill level of the hollow chamber. By dynamically changing the or each hollow chamber, these can be used to implement a massage function. The connection can, for example, be designed to allow a pluggable connection to a, preferably flexible, line through which fluid can be introduced and expelled.

The fluid can preferably be a gaseous fluid, preferably air. Of course, the use of a liquid fluid is also conceivable, which may have a lower compressibility if required. In this case, it is the responsibility of a person skilled in the art to select the necessary system technology to control the or each hollow chamber accordingly.

Alternatively or in addition to the arrangement of a connection on the or each corresponding plateau, at least one of the film blanks may have at least one linear recess formed therein. This allows the film blanks to be connected to each other by forming at least one channel that is fluidly connected to the or at least one hollow chamber. The connection can preferably be made along the recess between defining recess edges. Depending on the design, the or each channel can then be formed between the linear recess of one film blank and a corresponding, for example, flat region of the other film blank. In order to obtain a larger cross section, the or each channel can preferably be formed between the linear recess of one film blank and the linear recess of the other film blank. This means that the previously formed shape in at least one of the film blanks is sufficient to fill the or each hollow chamber with fluid or to expel it, without requiring additional components, such as at least one line. This enables fast and cost-effective manufacturing as well as a compact design of the device. Preferably, the connection of the film blanks to form at least one channel can be implemented by material bonding, particularly preferably by linear welding along the recess edges.

It is advantageous if the channel(s), preferably each channel, is/are fluidly connected via a single connection or multiple connection. In this way, the device has at least one connection option, for example, a pluggable or screwable, preferably detachable, connection option for connecting the channel(s) to a system that generates and controls the fluid flow. Preferably, this connection, or at least one of these connections, can be arranged on a common edge of the film blanks to achieve an overall compact design and/or easily accessible connection options.

According to a preferred embodiment, it can be provided that at least one of the film blanks consists of or contains thermoplastic polyurethane (TPU), at least in some regions. The advantage lies in its high flexibility and durability under repeated stress, combined with high dimensional and performance stability. Depending on the application, the strength of thermoplastic polyurethane can also be specifically adapted, as its properties offer a broad spectrum, ranging from soft and flexible to stiff and tough. Furthermore, it exhibits high mechanical strength and resistance to UV radiation and substances such as chemicals and oils, which makes it particularly suitable for use in demanding environments, such as those found in motor vehicles.

The device according to the invention features extremely low material usage and compact dimensions, while simultaneously offering high durability. In particular, the design of the stretching structure, which is incorporated into at least one film blank, allows for its rapid and streamlined shaping, enabling overall cost-effective manufacturing of the device.

Furthermore, the invention relates to a massage mat, which can preferably be arranged in a vehicle seat. The massage mat can have one of the three alternative compositions described in more detail below:

In a first alternative composition, the massage mat can have a carrier layer on which multiple devices according to the invention are arranged. Preferably, each of the devices then has only an individual hollow chamber, which is located either between the stretching structure of one film blank and the stretching structure or a, preferably flat, region of the other film blank. Specifically, the individual devices can each form, for example, an expansion body or a bladder. Advantageously, the individual devices can be materially bonded to the carrier layer, for example by gluing or welding.

According to a second alternative composition, the massage mat can have an individual device according to the invention in which only one of its two film blanks has multiple stretching structures. In this arrangement, the stretching structures of one film blank, together with preferably flat regions of the other film blank, enclose a common hollow chamber between them. The film blank which has no stretching structures can itself serve as a carrier layer and be described as such.

According to a third alternative composition, the massage mat can have an individual device according to the invention, in which both film blanks each have multiple stretching structures. In this arrangement, the stretching structures of one film blank, together with the stretching structures of the other film blank, enclose a common hollow chamber between them.

Furthermore, the invention relates to a seat, preferably a vehicle seat, which has at least one of the devices already mentioned above or an embodiment of the massage mat according to the invention described in more detail above.

The invention also relates to a method for manufacturing a device for manipulating a surface region of a seat, preferably a massage or adjustment device. The device to be manufactured can be the device according to the invention. In any case, the method according to the invention comprises the following steps:
Providing two film blanks;
Forming at least one stretching structure in at least one of the film blanks;
Arranging the film blanks at least partially one above the other;
Forming a fluid-fillable, hollow chamber in the region of the or each stretching structure between the film blanks by connecting them via a weld seam.

According to the invention, the or each corresponding stretching structure is formed by thermoforming. The or each stretching structure has a central plateau with annular folds and annular walls running around said central plateau, preferably coaxially or concentrically. The individual annular walls are arranged between two of these annular folds. Another annular wall is arranged between the plateau and the annular fold that runs closest around the plateau. The formation of the or each stretching structure can advantageously be carried out in such a way that its plateau, annular folds and annular walls are all simultaneously thermoformed into the associated film blank.

The method according to the invention enables the device to be manufactured with only a few work steps and in a manner that is easily automated. At the same time, only a small amount of material is required, as waste is preferably reduced to a minimum. All the parts necessary for forming the or each stretching structure can be simultaneously thermoformed into at least one of the film blanks, which allows for very high production cycle rates. In contrast to other designs that require the assembly of such a device, or at least the stretching structure thereof, from multiple parts to be joined together, the method according to the invention requires only an individual joining process in the form of a weld seam connecting the two film blanks.

Advantageously, a circumferential fold edge can be formed between an annular wall and an immediately adjacent annular fold of the or each stretching structure. Furthermore, preferably simultaneously, a circumferential fold edge can be formed between the plateau and the annular fold of the or each stretching structure that runs closest around the plateau. The fold edges define the individual parts of the or each stretching structure and determine the movement behavior thereof during the filling and emptying of the or each hollow chamber.

The invention provides that a connection, fluidly connected to the associated hollow chamber, can be arranged on the plateau of the or each stretching structure of at least one film blank. This connection can preferably be implemented by material bonding, for example, by gluing or welding.

In principle, within the scope of the method according to the invention, linear recesses can be formed in at least one of the film blanks by thermoforming. The arrangement of these recesses provides that each recess is connected to at least one stretching structure. In order to form one or more channels enclosed between a recess of one film blank and a recess of the other film blank, the film blanks are first placed one above the other accordingly. Alternatively or additionally, in order to form one or more channels enclosed between a recess of one film blank and a region of the other film blank, the film blanks are also first placed one above the other accordingly. In any case, the two film blanks are subsequently joined along the corresponding recess between defining recess edges. This can advantageously be implemented by material bonding, for example, by gluing or welding.

Before or after the channels are formed, individual single connections can be fluidly connected to one of the channels, or at least one multiple connection can be fluidly connected to at least some of the channels. These connections can be attached to the or at least one of the film blanks. Preferably, they can be attached to a common edge of the film blanks. The attachment is preferably implemented by material bonding, for example, by gluing or welding.

### BRIEF DESCRIPTION OF THE DRAWINGS

The invention is explained in more detail below with reference to two schematically illustrated embodiments as shown in the drawings.

FIG. 1 shows a first embodiment of the device according to the invention, preferably in the form of an expansion body or a bladder, in a perspective exploded view.

FIG. 2 shows a section through the device from FIG. 1 in its functional state.

FIG. 3 shows a second embodiment of the device according to the invention, in particular in the form of an expansion body or a bladder, in a perspective exploded view.

FIG. 4 shows a section through the device from FIG. 3 in a functional state.

FIG. 5 shows a first state of the device, using the device from FIG. 2 as an example, in the same view.

FIG. 6 shows a second state of the device, using the device from FIG. 2 as an example, in the same view.

FIG. 7 shows a third embodiment of the device according to the invention, preferably in the form of an expansion body or a bladder, in a cutaway view.

FIG. 8 shows a qualitative view of a fourth embodiment of the device according to the invention, preferably in the form of an expansion body or a bladder, in a plan view of one of its film blanks.

FIG. 9 shows a qualitative view of a fifth embodiment of the device according to the invention, preferably in the form of an expansion body or a bladder, in a plan view of one of its film blanks.

FIG. 10 shows a qualitative view of a sixth embodiment of the device according to the invention, preferably in the form of an expansion body or a bladder, in a plan view of one of its film blanks.

FIG. 11 shows a qualitative view of a seventh embodiment of the device according to the invention, preferably in the form of an expansion body or a bladder, in a plan view of one of its film blanks.

FIG. 12 shows an eighth embodiment of the device according to the invention, preferably in the form of a massage mat, in a perspective view.

### DETAILED DESCRIPTION OF PREFERRED EMBODIMENTS

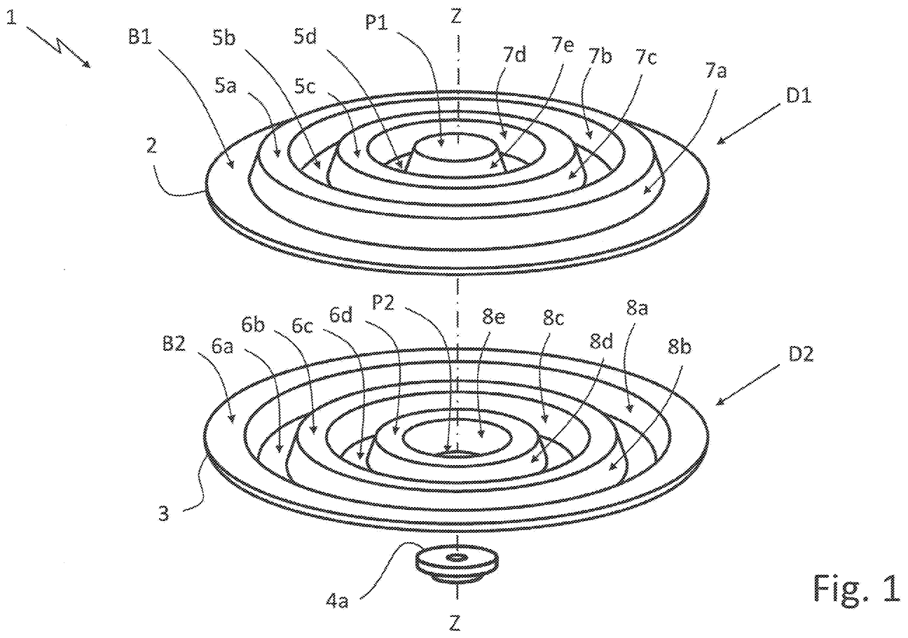

FIG. 1 shows a first embodiment of a device 1 according to the invention in a schematic representation of its perspective exploded view. The device 1 comprises two film blanks 2, 3 and a connection 4, which in this case is a single connection. This means that the connection 4 can be connected to an individual line, which is not shown in detail here. Preferably, the two film blanks 2, 3 can be made of thermoplastic polyurethane. In the example shown here, both film blanks 2, 3 each have a stretching structure D1, D2 formed therein. The stretching structures D1, D2 were formed in the corresponding film blanks 2, 3 by thermoforming. Each stretching structure D1, D2 visibly comprises individual annular walls 5a-5d, 6a-6d as well as annular folds 7a-7e, 8a-8e, which in the embodiment shown here are all arranged coaxially or concentrically to each other. Two immediately adjacent annular folds 7a-7e, 8a-8e are connected to each other by one of the annular walls 5a-5d, 6a-6d. The individual folds 7a-7e, 8a-8e run around a common stroke direction Z, which is perpendicular to the annular walls 5a-5d, 6a-6d. The individual annular walls 5a-5d, 6a-6d alternate in their vertical positions.

With regard to the first film blank 2, which is the upper film blank as shown in FIG. 1, the outermost first annular fold 7a thereof and the adjacent second annular fold 7b are connected by a first annular wall 5a, while the second annular fold 7b and the adjacent third annular fold 7c are connected by a second annular wall 5b, the third annular fold 7c and the adjacent fourth annular fold 7d are connected by a third annular wall 5c, and the fourth annular fold 7d and the adjacent fifth annular fold 7e that runs closest around the stroke direction Z are connected by a fourth annular wall 5d. With regard to the second film blank 3, which is the lower film blank as shown in FIG. 1, in the same way, the outermost first annular fold 8a thereof and the adjacent second annular fold 8b are connected by a first annular wall 6a, while the second annular fold 8b and the adjacent third annular fold 8c are connected by a second annular wall 6b, the third annular fold 8c and the adjacent fourth annular fold 8d are connected by a third annular wall 6c, and the fourth annular fold 8d and the adjacent fifth annular fold 8e that runs closest around the stroke direction Z are connected by a fourth annular wall 6d. The stretching structures D1, D2 of the two film blanks 2, 3 each have a central plateau P1, P2. With regard to the first film blank 2, the upper film blank as shown in FIG. 1, the annular wall 5d of the stretching structure D1 that runs closest around the stroke direction Z is connected to the plateau P1 by the fifth annular fold 7e. With regard to the second film blank 3, the lower film blank as shown in FIG. 1, the annular wall 6d of the stretching structure D2 that runs closest around the stroke direction Z is also connected to the plateau P2 by the fifth annular fold 8e.

For the purposes of this example, the two film blanks 2, 3 are identical.

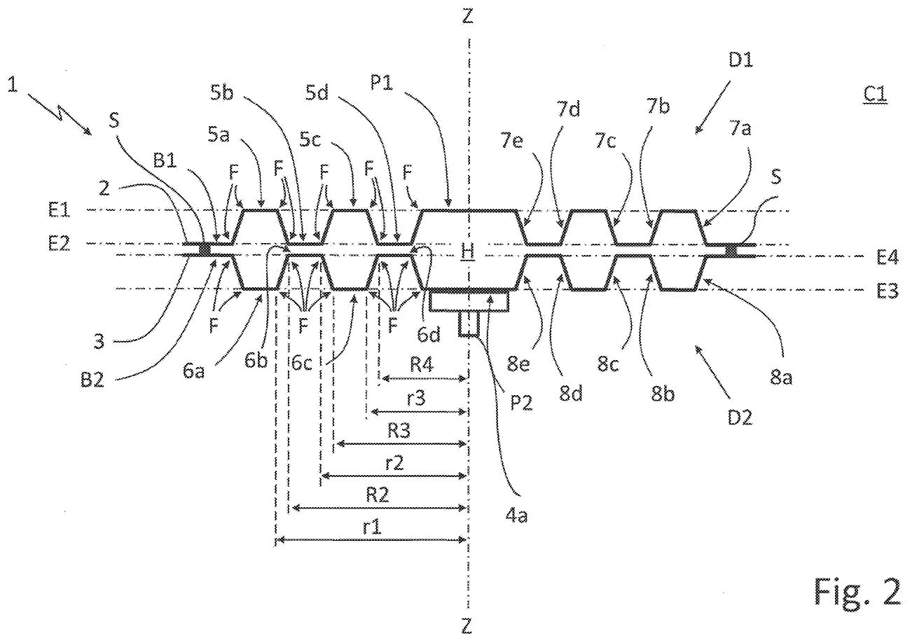

FIG. 2 shows a section through the device from FIG. 1, which is now in a functional state. For this purpose, the two film blanks 2, 3 were joined together by a circumferential weld seam S. As can be seen in the embodiment shown here, the two film blanks 2, 3 can each have an outer connecting edge B1, B2. Specifically, the weld seam S connects the connecting edges B1, B2 of the two film blanks 2, 3, in such a way that they enclose a fluid-fillable, hollow chamber H between them. Alternatively, the weld seam S can, of course, also be formed directly between the outer annular folds 7a, 8a of the two film blanks 2, 3, in a manner not shown in detail here, in order to connect them directly. A compressed state C1 of the two stretching structures D1, D2 is shown here, in which the device 1 has the smallest possible expansion in relation to the stroke direction Z. The individual annular folds 5a-5d, 6a-6d of the corresponding stretching structure D1, D2 are visibly staggered in such a way that they extend alternately in one of two planes E1, E2; E3, E4 which are spaced apart from and parallel to each other in relation to the stroke direction Z.

As can be seen particularly well in the section shown here, the individual annular folds 7a-7e; 8a-8e of each stretching structure D1, D2 are designed in such a way that they do not overlap in relation to a plane parallel to the stroke direction Z. Specifically, each stretching structure D1, D2 is designed in such a way that, for each pair of annular folds 7a-7e; 8a-8e connected by one of the annular walls 5a-5d; 6a-6d, the outer radius R2-R4 of the annular wall 5b-5d; 6b-6d that runs closer around the stroke direction Z is less than or equal to the inner radius r1-r3 of the other annular wall 5a-5c; 6a-6c. The connection 4, already visible in FIG. 1, is now arranged on the plateau P2 of the stretching structure D2 of the second film blank 3 (the lower film blank as shown in FIG. 1) in such a way that it is fluidly connected to the hollow chamber H. Furthermore, each annular fold 7a-7e; 8a-8e of the corresponding stretching structure D1, D2 is angled along a fold edge F relative to at least one annular wall 5a-5d; 6a-6d connected thereto. This also applies to the corresponding plateaus P1, P2 of the stretching structures D1, D2, each of which is defined by a circumferential fold edge F along which the annular fold 7e, 8e that runs closest around the stroke direction Z is connected to the corresponding plateau P1, P2 and can be angled relative thereto.

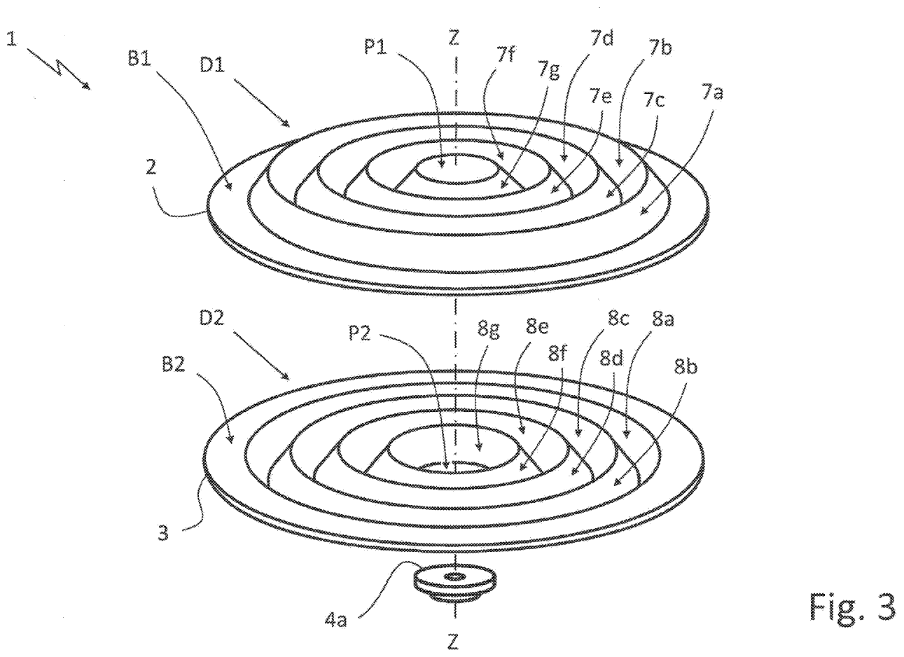

FIG. 3 shows a second embodiment of the device 1 according to the invention in a schematic illustration of its perspective exploded view. In contrast to the first embodiment shown in FIGS. 1 and 2, the two film blanks 2, 3 do not have any annular walls 5a-5d; 6a-6d, but only successive and directly interconnected annular folds 7a-7f; 8a-8f.

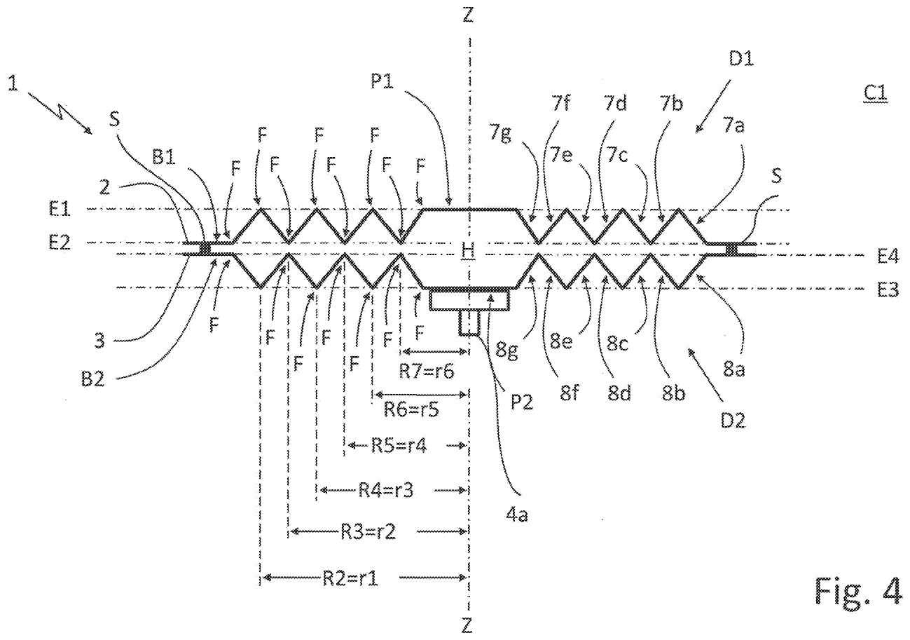

FIG. 4 shows a section through the device from FIG. 3, which is also now in a functional state. In order to avoid repetition, reference is made here, at least in substance, to the preceding explanations relating to FIG. 2, whereby the same reference signs clarify the same features. Even with the design according to the second embodiment, the outer radius R2-R7 of the annular fold 7b-7g; 8b-8g that runs closer around the stroke direction Z is equal to the inner radius r1-r6 of the annular fold 7a-7f; 8a-8f connected thereto, with respect to two directly interconnected annular folds 7a-7f; 8a-8f.

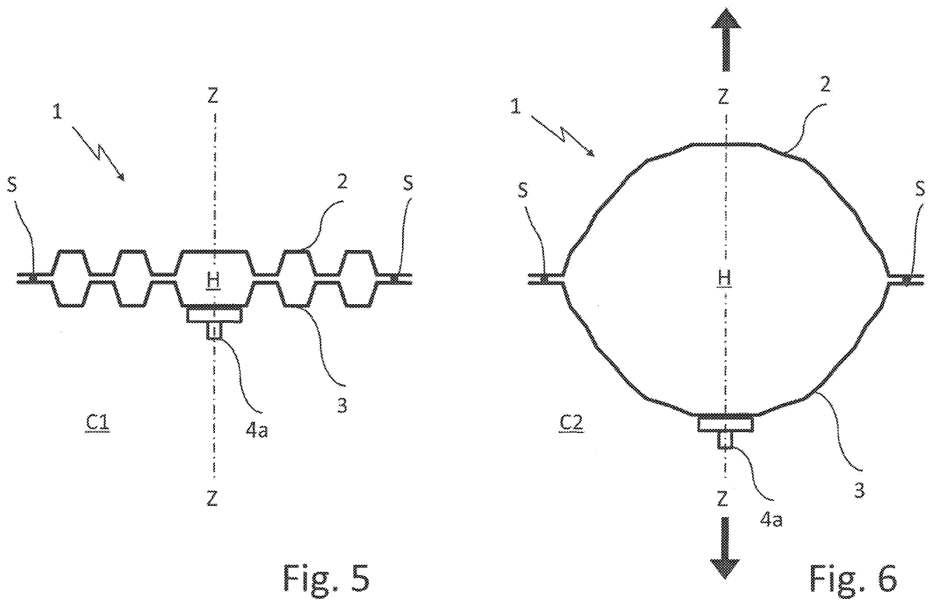

FIG. 5 again shows the device 1 in its compressed state C1 based on the embodiment chosen shown in FIG. 2, which is purely exemplary.

FIG. 6, on the other hand, shows an expanded state C2 of the device 1 based on the embodiment shown in FIG. 5, which is purely exemplary. It is self-evident that the view in FIG. 6 also shows, in substance, the expanded state C2 of the device 1 from FIGS. 3 and 4 according to the second embodiment, as well as all other embodiments described below. The resulting expansion of the device 1 in relation to the stroke direction Z is indicated by black arrows. As can be seen, the expansion of the stretching structures D1, D2, which at least partially define them, in relation to the stroke direction Z can be changed from the compressed state C1 to the expanded state C2 and back again by a corresponding change in the fill level of the hollow chamber H via the introduction and expulsion of fluid through the connection 4a.

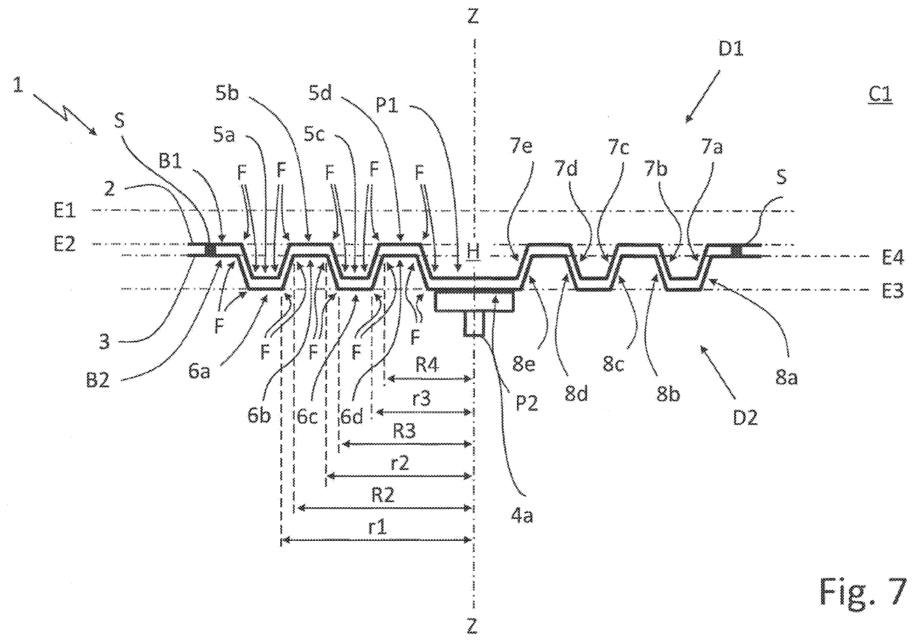

FIG. 7 shows a third embodiment of the device 1, the film blanks 2, 3 of which—as shown here by way of example, analogous to the first embodiment—comprise both annular folds 7a-7f; 8a-8f and annular walls 5a-5d; 6a-6d. Of course, the film blanks 2, 3 can—analogous to the second embodiment—comprise only annular folds 7a-7f; 8a-8f, in a manner not shown here. The main difference to the previously described embodiments lies in the relative arrangement of the stretching structures D1, D2 to each other, wherein one of the two film blanks 2, 3 is rotated by 180° in relation to an axis perpendicular to the stroke direction Z, so that the annular folds 7a-7f; 8a-8f of both film blanks 2, 3 now run parallel to each other. In other words, the two stretching structures D1, D2 of the film blanks 2, 3 are virtually nested inside each other, resulting in a lower overall height for the device 1 in its compressed state C1 shown here. For better clarity, the planes E1-E4 shown in FIGS. 2 and 4 have also been retained in FIG. 7 to show that the overall height of the device 1 now extends only between the second plane E2 and the third plane E3, whereas in the two embodiments of FIGS. 2 and 3 it has an almost twice as great height between the first plane E1 and the third plane E3.

The arrangement of the two film blanks 2, 3 shown in FIG. 7 can also be used for all other embodiments of the stretching structures D1, D2, which are described in more detail below.

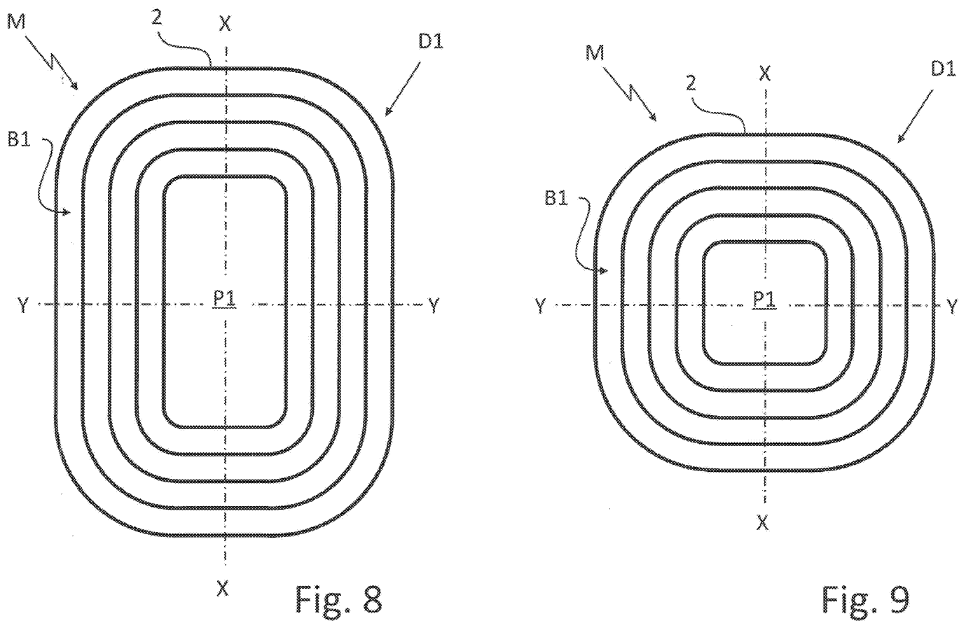

FIGS. 8 to 11 each show a plan view in the stroke direction Z of further possible embodiments of the device 1. The focus here is, purely by way of example, on their corresponding first film blank 2. FIGS. 8 to 11 show purely qualitative views in relation to further possible outer shapes of the device 1 as well as further possible patterns M of the stretching structures D1, D2, which are purely exemplary and refer to the first stretching structure D1 but can also apply to the second stretching structure D2 of the second film blank 3. It is self-evident that the pattern M of the stretching structure D1 can result from the, in particular nested, course of its fold edges F as well as annular folds 7a-7e; 8a-8e and annular walls 5a-5d; 6a-6d (see embodiment according to FIGS. 1, 2 and 7) or only its fold edges F and annular folds 7a-7g; 8a-8g (see embodiment according to FIGS. 3 and 4), which each extend around the plateau P1. By way of example, all these embodiments also include the connecting edge B1, which, however, can also be omitted—as already described elsewhere.

FIG. 8 shows a fourth embodiment of the device 1, the outer shape of which can be described as rectangular with rounded corners. Similarly, the stretching structure D1 also shows rectangles nested inside each other and spaced apart, each with rounded corners. The stretching structure D1 can be considered symmetrical along a longitudinal axis X and along a transverse axis Y. As can be seen, the device 1, purely by way of example, extends slightly more in the longitudinal direction X than in the transverse direction Y. Thus, the shape of the device 1 lies within a rectangle that defines its boundaries (not shown in detail).

FIG. 9 shows a fifth embodiment of the device 1, the outer shape of which can be described as square with rounded corners. Similarly, the stretching structure D1 also shows squares nested inside each other and spaced apart, each with rounded corners. Here too, the stretching structure D1 can be considered symmetrical along the longitudinal axis X and along the transverse axis Y.

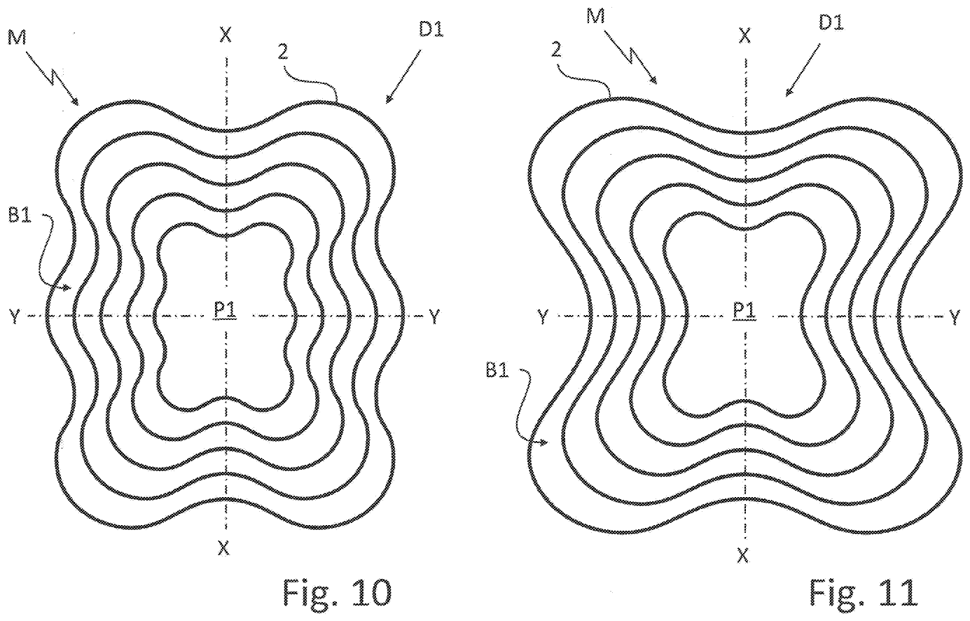

FIG. 10 shows a sixth embodiment of the device 1, the outer shape of which can be described as wavy overall. Similarly, the stretching structure D1 also shows waveforms nested inside each other and spaced apart. Here too, the stretching structure D1 can be considered symmetrical along the longitudinal axis X and along the transverse axis Y. As can be seen, the device 1, purely by way of example, extends slightly more in the longitudinal direction X than in the transverse direction Y. Thus, the shape of the device 1 lies within a rectangle that defines its boundaries (not shown in detail). The two edges of the device 1 running relative to the longitudinal axis X, as well as the associated part of the pattern M of the stretching structure D1, are wavier than the two edges of the device 1 running relative to the transverse axis Y, as well as the associated part of the pattern M of the stretching structure D1.

FIG. 11 shows a seventh embodiment of the device 1, the outer shape of which can also be described as wavy. However, in this embodiment, the edges of the device 1 relative to the longitudinal axis X and the transverse axis Y, as well as the corresponding corresponding part of the pattern M of the stretching structure D1, exhibit a similar or even identical waveform. Overall, the outer shape of the device 1 could therefore be described as a simple flower shape. Similarly, the stretching structure D1 also exhibits simple flower shapes nested inside each other and spaced apart. Here too, the stretching structure D1 can be considered symmetrical along both the longitudinal axis X and the transverse axis Y. As can be seen, the device 1 here, also purely as an example, extends slightly more in the longitudinal direction X than in the transverse direction Y. Thus, the shape of device 1 lies within a rectangle that defines its boundaries (not shown in detail).

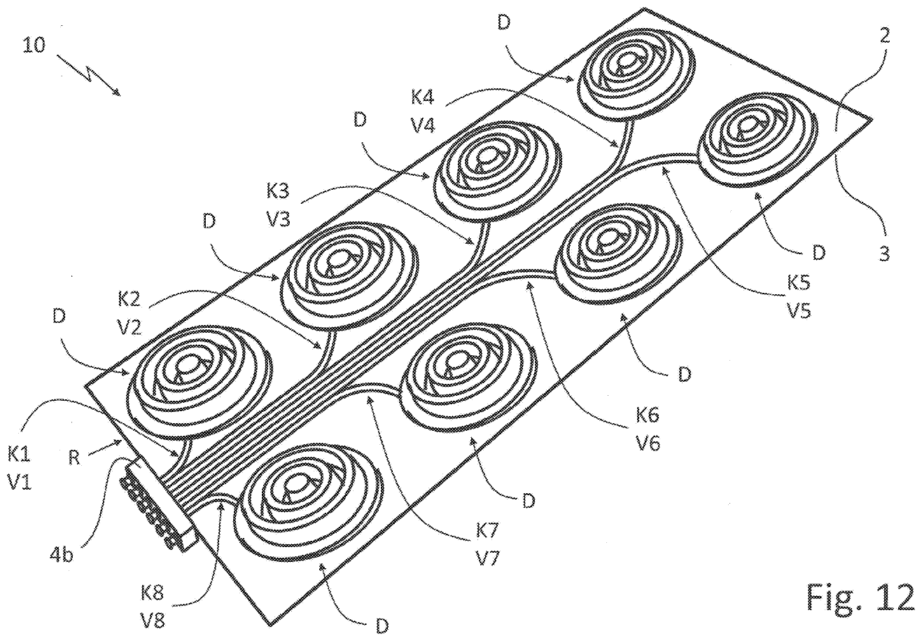

FIG. 12 shows an alternative design of the stretching structures D1, D2 of the device 1, which—as can be seen here and analogous to the first embodiment—can comprise both annular folds 7a-7f; 8a-8f and annular walls 5a-5d; 6a-6d as well as analogous to the second embodiment and not shown here-only annular folds 7a-7f; 8a-8f. In principle, the stretching structures can also take all other alternative forms of the embodiments described previously and not shown in detail here. The main difference to the previously described embodiments lies in the shape of the corresponding stretching structure D1, D2, which is no longer circular, but represents a different possible design.

FIG. 12 shows an eighth embodiment of the device 10 according to the invention in a schematic perspective view. It can be seen that at least one of the two film blanks 2, 3 has a plurality of stretching structures D, so that the device can be described as a massage mat 10. The second film blank 3, shown below in FIG. 5, can serve as the carrier layer. By way of example, each of the stretching structures D here—and analogous to the first embodiment—has both annular folds 7a-7e; 8a-8e and annular walls 5a-5d; 6a-6d, but can also—not shown in detail—comprise only annular folds 7a-7g; 8a-8g as in the second embodiment. Unlike the other embodiments of the device 1 according to the invention, the stretching structures D themselves do not have any connections here. Rather, the stretching structures are fluidly connected to individual channels K1-K8, which are formed between the two film blanks 2, 3. Specifically, at least one of the film blanks 2, 3 has at least one linear recess V1-V2 formed therein. In a manner not shown in detail here, each recess V1-V8 can have, for example, a U-shaped cross section in the section of the corresponding film blank 2, 3. The film blanks 2, 3 are connected by multiple fluidly connected channels K1-K8, each of which is linked to a hollow chamber H of the individual stretching structures D. This connection can preferably be made along the recesses V1-V8 between defining recess edges, preferably by welding. The channels K1-K8 extending away from the stretching structures D all converge on a common edge R of the film blanks 2, 3, at which a multiple connection 4b is arranged. The individual channels K1-K8 are fluidly connected in a suitable manner to the individual connections of the multiple connection 4b.

### LIST OF REFERENCE SIGNS

1—device
2—film blank of 1 or 10
3—film blank of 1 or 10
4a—connection or single connection of 1 or 10
4b—multiple connection of 10
5a—first annular wall of D or D1
5b—second annular wall of D or D1
5c—third annular wall of D or D1
5d—fourth annular wall of D or D1
6a—first annular wall of D or D2
6b—second annular wall of D or D2
6c—third annular wall of D or D2
6d—fourth annular wall of D or D2
7a—first annular fold of D or D1
7b—second annular fold of D or D1
7c—third annular fold of D or D1
7d—fourth annular fold of D or D1
7e—fifth annular fold of D or D1
7f—sixth annular fold of D or D1
7g—seventh annular fold of D or D1
8a—first annular fold of D or D1
8b—second annular fold of D or D1
8c—third annular fold of D or D1
8d—fourth annular fold of D or D1
8e—fifth annular fold of D or D1
8f—sixth annular fold of D or D1
8g—seventh annular fold of D or D1
B1—connecting edge of 2
B2—connecting edge of 3
C1—compressed state of D or D1 or D2
C2—expanded state of D or D1 or D2
D—stretching structure of 2 and/or 3
D1—stretching structure of 2
D2—stretching structure of 3
E1—first plane of 5a and 5c or F between 7a-7g
E2—second plane of 5a and 5d or F between 7a-7g
E3—first plane of 6a and 6c or F between 8a-8g
E4—second plane of 6a and 6d or F between 8a-8g
F—fold edge between 5a-5e and 7a-7e or 6a-6e and 8a-8e
H—hollow chamber
K1—first channel of 10
K2—second channel of 10
K3—third channel of 10
K4—fourth channel of 10
K5—fifth channel of 10
K6—sixth channel of 10
K7—seventh channel of 10
K8—eighth channel of 10
M—pattern consisting of 5a-5d and/or 7a-7g and/or F
P1—plateau of D or D1
P2—plateau of D or D2
r1—inner radius of 5a or 6a
r2—inner radius of 5b or 6b
R2—outer radius of 5b or 6b
r3—inner radius of 5c or 6c
R3—outer radius of 5c or 6c
r4—inner radius of 5d or 6d
R4—outer radius of 5d or 6d
R5—outer radius of 5e or 6e
S—weld seam between 2 and 3
V1—first recess of K1
V2—recess of K2
V3—recess of K3
V4—recess of K4
V5—recess of K5
V6—recess of K6
V7—recess of K7
V8—recess of K8
X—longitudinal axis of D1 and/or D2
Y—transverse axis of D1 and/or D2
Z—stroke direction

What is claimed is:

1. A device (1, 10) for manipulating a surface region of a seat, preferably a massage or adjustment device, comprising two film blanks (2, 3), at least one of which film blank (2, 3) has at least one stretching structure (D, D1, D2) formed therein, in the region of which the two film blanks (2, 3) are connected to each other by a weld seam(S) in such a way that they enclose a fluid-fillable, hollow chamber (H) between them, wherein by changing the fill level of the or each hollow chamber (H), the expansion of the stretching structure (D, D1, D2), which at least partially defines it, can be changed in relation to a stroke direction (Z) from a compressed state (C1) to an expanded state (C2) and back, wherein the corresponding stretching structure (D, D1, D2) has annular folds (7a-7g; 8a-8g) running around the stroke direction (Z) thereof, preferably coaxially or concentrically, wherein either at least two or each pair of annular folds (7a-7g;
8a-8g) are directly connected to each other and the outer radius (R2-R7) of the annular fold (7b-7g; 8b-8g) that runs closer around the stroke direction (Z) is equal to the inner radius (r1-r6) of the annular fold (7a-7f; 8a-8f) connected thereto, or/and at least two or each pair of annular folds (7a-7e; 8a-8e) are connected to each other by an annular wall (5a-5d; 6a-6d) and the outer radius (R2-R4) of the annular wall (5b-5d; 6b-6d) that runs closer around the stroke direction (Z) is less than or equal to the inner radius (r1-r3) of the other annular wall (5a-5c; 6a-6c).

2. The device (1, 10) according to claim 1, wherein each annular fold (7a-7g; 8-8g) of the or each stretching structure (D, D1, D2) is angled along a preferably round or circular fold edge (F) relative to at least one annular wall (5a-5d; 6a-6d) and/or annular fold (7a-7g; 8-8g) connected thereto.

3. The device (1, 10) according to claim 1, wherein in the compressed state (C1) of the corresponding stretching structure (D, D1, D2), the annular walls (5a-5d;
6a-6d) thereof extend alternately in one of two planes (E1, E2; E3, E4) which are spaced apart from each other, preferably parallel to each other, in relation to the stroke direction (Z).

4. The device (1, 10) according to claim 1, wherein the corresponding stretching structure (D, D1, D2) has a central, preferably round or circular, plateau (P1, P2) which is defined by a circumferential fold edge (F), wherein the annular wall (5a-5d;
6a-6d) of the stretching structure (D, D1, D2) that runs closest around the stroke direction (Z) is connected to the plateau (P1, P2) by an annular fold (7e; 8e) along this fold edge (F) and can be angled relative thereto.

5. The device (1, 10) according to claim 4, further comprising a connection (4a) provided on the plateau (P1, P2) of the or each stretching structure (D, D1, D2), which is fluidly connected to the or each associated hollow chamber (H).

6. The device (1, 10) according to claim 1, wherein at least one of the film blanks (2, 3) has at least one linear recess (V1-V8) formed therein, wherein the film blanks (2, 3) are connected to each other, preferably welded, by forming at least one channel (K1-K8) that is fluidly connected to the or at least one hollow chamber (H) along the recess (V1-V8) between defining recess edges.

7. A massage mat (10), preferably for a vehicle seat, comprising one of the following alternative compositions:
a) a carrier layer having multiple devices (1) according to claim 1 arranged thereon, preferably by means of welding;
b) a device (1) according to claim 1, wherein only one of the film blanks (2, 3) has multiple stretching structures (D, D1, D2), wherein the stretching structures (D, D1, D2) of one film blank (2, 3) together with regions of the other film blank (2, 3), preferably serving as a carrier layer, each enclose a common hollow chamber (H) between them; or
c) a device (1) according to claim 1, wherein both film blanks (2, 3) each have multiple stretching structures (D, D1, D2), wherein the stretching structures (D, D1, D2) of one film blank (2, 3) together with the stretching structures (D, D1, D2) of the other film blank (2, 3) each enclose a common hollow chamber (H) between them.

8. A method for manufacturing a device (1) for manipulating a surface region of a seat, preferably a massage or adjustment device according to claim 1, comprising the steps of:
providing two film blanks (2, 3);
forming at least one stretching structure (D, D1, D2) in at least one of the film blanks (2, 3);
arranging the film blanks (2, 3) at least partially one above the other;
forming a fluid-fillable, hollow chamber (H) in the region of the or each stretching structure (D, D1, D2) between the film blanks (2, 3) by connecting them via a weld seam(S),
wherein the stretching structure (D, D1, D2) or each stretching structure (D, D1, D2) is formed by thermoforming, which has a central plateau (P1, P2), wherein annular folds (7a-7g; 8a-8g) or annular walls (5a-7d; 6a-6d) and annular folds (7a-7e; 8a-8e) are formed around the plateau (P1, P2), preferably coaxially or concentrically, which are arranged both between two of these annular walls (7a-7g; 8a-8g) and between the plateau (P1, P2) and the annular wall (5d; 6d) that runs closest around the plateau.

9. The method according to claim 8, further comprising forming a circumferential fold edge (F) between the plateau (P1, P2) and the annular fold (7e, 7g; 8e, 8g) connected thereto, as well as either between each annular fold (7a-7g; 8a-8g) or between each annular fold (7a-7e; 8a-8e) and an immediately adjacent annular wall (5a-5d; 6a-6d) of the or each stretching structure (D, D1, D2).

10. The method according to claim 8, further comprising arranging a connection (4a, 4b), fluidly connected to the associated hollow chamber (H), preferably welded, on the plateau (P1, P2) of the or each stretching structure (D, D1, D2) of at least one film blank (2, 3).

11. The method according to claim 8, further comprising forming linear recesses (V1-V8) in at least one of the film blanks (2, 3) by thermoforming, each of which is connected to at least one stretching structure (D, D1, D2), wherein the film blanks (2, 3) are placed one above the other to form channels (K1-K8) enclosed between a recess (V1-V8) of one film blank (2, 3) and a recess (V1-V8) of the other film blank (2, 3) or a region of the other film blank (2, 3) and are connected to each other, preferably welded, along the corresponding recess (V1-V8) between defining recess edges.

12. The method according to claim 11, before or after the channels (K1-K8) are formed, attaching individual single connections (4a) each fluidly connected to one of the channels (K1-K8), or at least one multiple connection (4b) fluidly connected to at least some of the channels (K1-K8), preferably welded, to the or at least one of the film blanks (2, 3), preferably to a common edge (R) of the film blanks (2, 3).
